(19) United States
(12) Patent Application Publication
(10) Pub. No.: US 2001/0015719 A1
(43) Pub. Date: Aug. 23, 2001

(54) REMOTE CONTROL HAS ANIMATED GUI

(75) Inventors: JAN VAN EE, SAN JOSE, CA (US); PAUL S. MOORE, EINHOVEN (NL); GUY J. ROBERTS, EINDHOVEN (NL)

Correspondence Address: PHILIPS ELECTRONICS NORTH AMERICA CORPORATION, CORPORATE INTELLECTUAL PROPERTY, 580 WHITE PLAINS RD, TARRYTOWN, NY, 10591, US

(73) Assignee: U.S. PHILIPS CORPORATION

(21) Appl. No.: 09/128,839

(22) Filed: Aug. 4, 1998

(51) Int. Cl. G09G 5/08

(52) U.S. Cl. 345/158

(57) ABSTRACT

A remote control device for remote control of home theater equipment has a display with a touch screen representing a GUI. User-activation of the GUI causes its appearance to change. The change is effected through animation. Animation is the simulation of movement created by displaying a series of bitmaps. The animation lets the user perceive the change as a smooth transition. Thus the impression is avoided of an abrupt confrontation with a new lay-out.

### FIELD OF THE INVENTION

The invention relates to a handheld remote control device, in particular for control of consumer electronics or home theater equipment. The device has a GUI (graphical user-interface) with graphical representations for soft keys or icons that enable the user to control the equipment.

### BACKGROUND ART

An interactive user-interface with graphical representations is commonly referred to as a GUI. Icons are well known in the art of graphical user-interfaces for control of a computer. An icon is a small pictorial representation of some larger set of information. An icon provides graphical information in a condensed format about contents or status of the underlying system. Icons are designed to trigger, through visual perception, operator concepts that communicate the contents or operation of the system in a quick manner. The system is accessed or operated upon through actuation of the icon.

An example of a controller unit for a home entertainment system is the Stage 3 Controller unit of Kenwood, described in Kenwood's publicly available manual “STAGE 3/ Setting up your KC-Z1 Controller”, 1996. The control unit includes a hand-held controller with a touch screen functionality for the GUI. The GUI provides a large number of icons that correspond to a large number of system functionalities. The functionalities are activated through the icons on the touch screen. The GUI is user-programmable to select the icons that should be present in the main menu and those that should not. In addition, the control modes (e.g., IR control codes, balancing audio speaker system) of the components thus selected can be programmed.

Icons in general are meant to convey information to the user in a quick manner through an appropriate graphical representation. However, if a large number of icons are presented at any of a variety of levels in a hierarchy of icons, the user has to actually read, i.e., decipher, the screen's information content to locate the desired functionality. As a result, the user-friendliness of the system control aspects can easily be degraded if too much information is presented in too many different icon-arrangements.

### OBJECT OF THE INVENTION

The above emphasizes that the graphical design of a GUI, its lay-out and its icons, is crucial to the user-friendliness of the remote. Another aspect of GUI user-friendliness to be considered is the dynamics of the navigation among the panels of icons. The term “panel” refers to the organization of one or more clusters of icons and soft keys. When the user activates a specific icon in the panel shown on the GUI of the known remote, the GUI changes to a next panel. The transition, however, is abrupt in the sense that the successive panels can be perceived by the user as unrelated until he/she actually reads the icons. The user may thus experience a lack of familiarity with the guidance throughout navigation among the panels and a feeling of being confronted with information that is first to be interpreted anew to determine the context before the user can make a selection from the new panel's menu. Especially in a home theater environment this distraction from the entertainment aspect is undesirable.

It is therefore an object of the invention to provide a remote control device that has a user-friendly GUI with ergonomically designed panel visualization, more so than that of the prior art.

### SUMMARY OF THE INVENTION

To this end, the invention provides a remote control device for remote control of equipment such as a home theater. The remote has a display for display of a GUI that enables a user to interact with the device. User-interaction with the device causes the GUI to undergo a change in appearance. The change is effected through animation. Animation is the simulation of movement created by displaying a series of pictures, or frames, e.g., bitmaps. For example, a panel with clustered control options slides out of view and a next one slides into view, or displayed icons slide to new positions while new icons appear, etc. Through the animation, the user perceives the development from one panel to the other as a continuous transition. The impression is created of a gradually changing lay-out, of scrolling panels, of sliding, rotating, expanding or contracting icons, etc. Thus, the animation avoids the impression of an abrupt confrontation with a new lay-out.

### BRIEF DESCRIPTION OF THE DRAWINGS

The invention is explained by way of example and with reference to the accompanying drawings, wherein:

FIG. 1 is a diagram of a remote control device in the invention;

FIGS. 2-7 show a sequence of frames that give the impression of scrolling panels on the GUI of the remote when displayed at a proper rate; and

FIGS. 8-12 show a sequence of frames to give the impression of a rotating icon on the GUI of the remote.

Throughout the figures, same reference numerals indicate similar or corresponding features.

### PREFERRED EMBODIMENTS

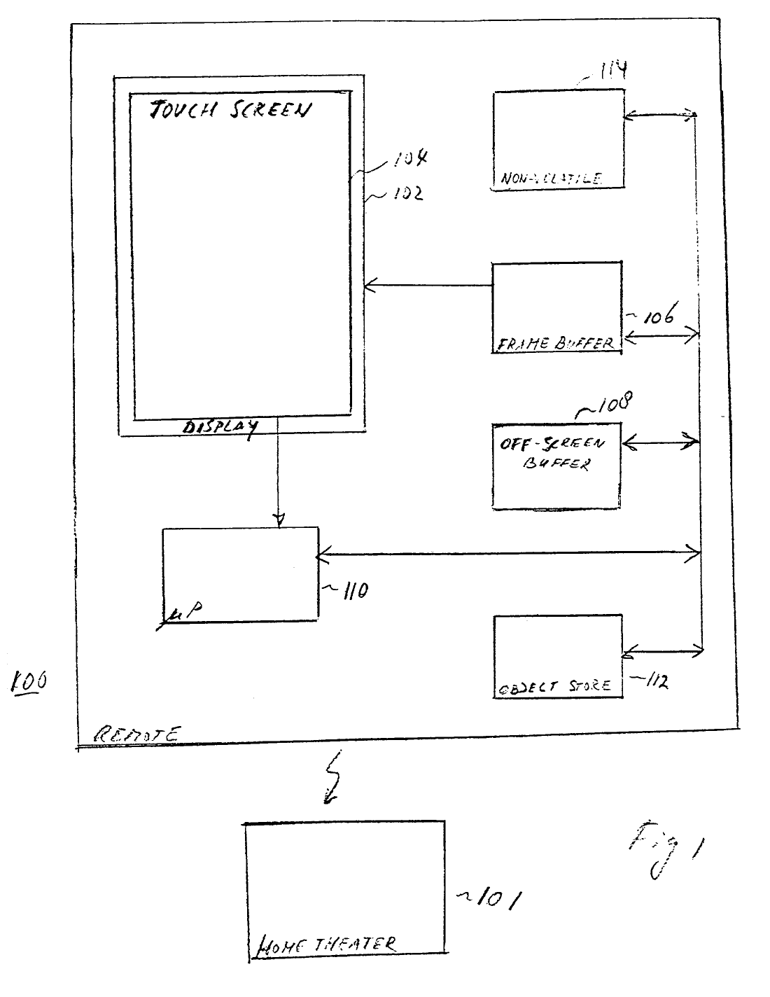

FIG. 1 is a block diagram with main components of a remote control device 100 in the invention for control of home theater equipment 101 through a wireless protocol in IR or RF. Remote 100 comprises a display 102 for display of a GUI and a touch screen 104 for activating a user-selectable option of the GUI. Display 102 comprises an LCD. Touch screen 104 is, for example, a resistive tablet. For more background on such input devices, see, for example, U.S. Pats. Nos. 5,402,151; 5,231,381; 5,777,607 and 5,767,458 of Philips Electronics, all incorporated herein by reference. In the preferred embodiment, LCD 102 and touch screen 104 are physically integrated, and the combination has screen dimensions of about 77×58 mm for the active area, and about 81×62 mm for the visible area. The screen resolution is about 4 pixels per mm. Remote 100 comprises a frame buffer 106, an off-screen memory 108, a microprocessor 110, an object store 112 and a non-volatile memory 114. Frame buffer 106 is coupled to display 102 and stores the information content shown on display 102. Off-screen buffer 108 stores bitmaps that are mapped into frame buffer 106 under control of a software bitblitter run on microprocessor 110. Microprocessor 110 receives user-input via touch screen 104 and translates the input into associated GUI actions via framebuffer 106 and off-screen buffer 108. Object store 112 lists the data to be rendered in off-screen buffer 108 and/or in frame buffer 106 by microprocessor 110. Non-volatile memory 114 stores data files that describe the GUI. The description of the GUI is in a universal format, e.g., <“panel”; “parameters”>, so that it can be interpreted platform-independently. Interpretation creates objects, e.g., in C++, for object store 212, or creates bitmaps for buffers 206 and 208, all under program control. The description is converted into objects, e.g., in C++, for object store 112, or directly into bitmaps for buffers 106 and 108, all under program control. Buffers 106 and 108, and object store 112 can be parts of the same physical memory device. In the preferred embodiment, processor 110 is a MC68328 of Motorola. Buffers 106 and 108, together with object store 112 are implemented in a 512 kbyte SRAM, e.g., a KM616Y4000BLT-7L of Samsung. Non-volatile memory 114 is, for example, a 1Mbyte flash memory TE28F800B3B90 of Intel.

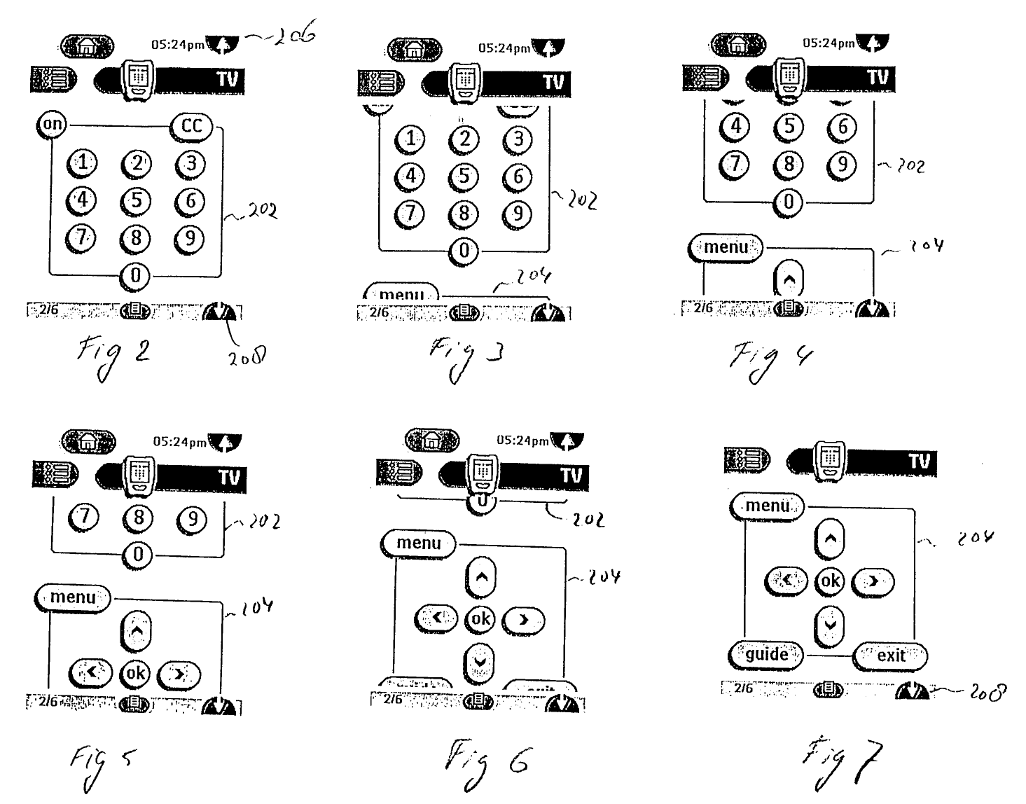

The GUI has user-selectable menu options that are arranged in various panels and sections of panels. A panel is, for example, a cluster of options displayed together. Selecting a particular one of the options in a particular one of the panels through touch screen 104 causes the GUI to change its appearance, e.g., to another one of the sections or another one of the panels. Animation is used to visualize that another panel or section of the GUI is activated. These animations are implemented, for example, by using a combination of copying parts of bitmaps in off-screen buffer 108 to one or more areas in frame buffer 106, and filling other areas of frame buffer 106 with copies of some regions in frame buffer 106 in case a graphical representation is shifted across display 102. This is explained in more detail further below with reference to the examples of FIGS. 2-6.

FIGS. 2-7 illustrate a sequence of images creating animation to give the impression that control panels 202 and 204 are scrolled in and out of view by actuating soft keys 206 for scroll up and 208 for scroll down. Panel 202 is, for example, a clustering of numerical soft keys for channel selection on a TV. Panel 204 is, for example, a cursor control menu with soft keys to move a cursor on a menu in an on-screen display of the TV (not shown) and to make a selection among the items. The scrolling is implemented by rendering a new panel 204 into off-screen buffer 108, and by a sequence of copy actions in frame buffer 106 to scroll new panel 204 into view and the old panel 202 out of view.

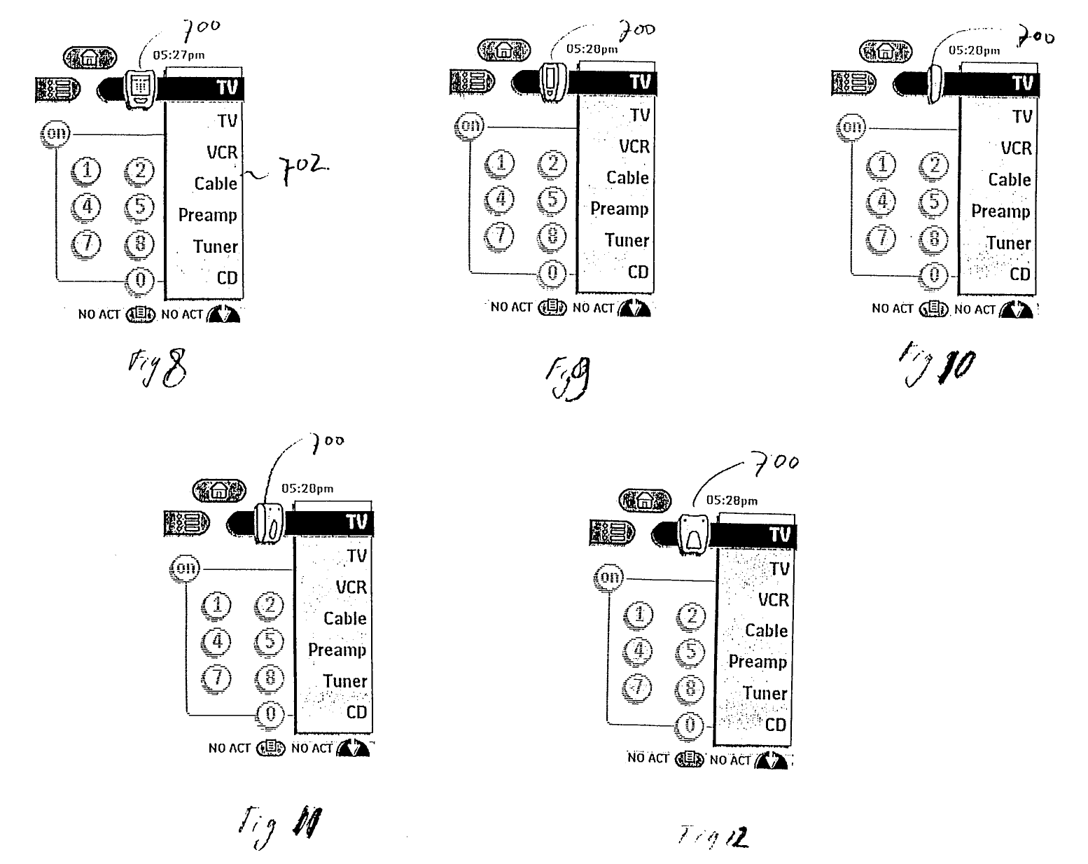

FIGS. 8-12 illustrate how animation is being used to indicate a specific state of a controlled piece of equipment. For example, a graphical representation of icon 700 is being rotated to indicate that remote 100 will not transmit an IR code in order to switch sources for a pre-amplifier (as in the DVX8000 of Philips Electronics, not shown) when a new device in the system has been activated. This is explained in more detail as follows. During normal operation of remote 100, selecting in menu 702 an apparatus of the home theater equipment, e.g., a TV, causes the preamplifier to switch to the apparatus selected. However, there are circumstances wherein the user should be able to control an apparatus without causing the preamplifier to switch to the apparatus newly selected. For example, the user has the DVD player (not shown) connected to the display of a TV apparatus (not shown) and is watching a DVD movie. The user now wants to rewind a video tape of the VCR (not shown). In normal operation, the user would go to menu 702 and select the VCR. However, this causes the tape in the VCR to be shown on the TV because the source would be switched. Remote 100 has been designed to allow the user to select an apparatus from the apparatus-menu without switching sources. A hard key (not shown) on remote 100 is to be held depressed during selection from menu 702 in order to prevent source switching. To communicate to the user that selecting does not result into the undesired switching, i.e., the remote assumes a “no action” phase, icon 700 is rotated on its back. This animation has a number (here 5) of bitmaps, each displaying the representation of remote 100, i.e., icon 700, from a different angle. The bitmaps are stored in off-screen buffer 108. Icon 700 is being rotated by copying consecutive bitmaps to frame buffer 106.

I claim:

1. A remote control device for remote control of equipment, wherein:
the device has a display for display of a GUI;
the GUI enables a user to interact with the device:
user-interaction with the device causes the GUI to undergo a change in appearance; and
the change is effected through animation.

2. The device of claim 1, comprising:
a frame buffer coupled to the display;
an off-screen buffer for storage of bitmap data; and
a bitblitter functionality to copy data from the off-screen buffer to the frame buffer.

3. The device of claim 2, comprising:
an object store for storing object data and
a rendering functionality for rendering the object data in at least the off-screen buffer or the frame buffer.

4. The device of claim 1, wherein the animation creates an impression of scrolling a panel.

5. The device of claim 1, wherein the animation creates an impression of sliding a graphics element.

6. The device of claim 1, wherein the animation creates an impression of rotating a graphics element.

7. The device of claim 1, wherein the animation creates an impression of changing a size of a graphics element.

8. The device of claim 1, comprising a touch screen.

9. The device of claim 1, wherein the GUI comprises control information for control of consumer electronics equipment.

10. A method of enabling a user to interact with electronic equipment through a hand-held remote control device, the method comprising:
enabling the device to present a GUI for user-activation; and
changing the GUI through animation upon a user-interaction with the GUI.
